(19) United States
(12) Patent Application Publication
(10) Pub. No.: US 2019/0054988 A1
(43) Pub. Date: Feb. 21, 2019

(54) SNORKELING TUBE STRUCTURE AND METHOD OF MANUFACTURING THE SAME

(71) Applicant: QBAS CO., LTD., Taipei (TW)

(72) Inventor: Chih-Cheng SHIUE, Taipei (TW)

(21) Appl. No.: 16/022,868

(22) Filed: Jun. 29, 2018

(30) Foreign Application Priority Data
Aug. 15, 2017 (TW) 106127665

(51) Int. Cl. B63C 11/20; B29C 49/06; B29C 49/00

(52) U.S. Cl. CPC B63C 11/205; B29C 49/06; B29L 2023/004; B29C 2049/0089; B29C 49/0084

(57) ABSTRACT

A snorkeling tube structure with a tube body and a partition portion is provided. The tube body is formed along an axis and has an outer surface and an inner surface which encircles the axis to define an air passage; the axis includes a curved section. The partition portion is formed integrally with the tube body along the axis, and disposed on the inner surface of tube body to divide the air passage into an intake passage and an outtake passage. A method of manufacturing a snorkeling tube structure is also provided, including the following steps: forming a parison including a first passage and a second passage; placing the parison in a mold cavity; injecting air into the first and second passages to inflate the parison towards a wall of the mold cavity; and removing the inflated parison from the mold to get a snorkeling tube structure.

### CROSS-REFERENCES TO RELATED APPLICATIONS

This application claims priority to Taiwan Patent Application No. 106127665 filed on Aug. 15, 2017, which is hereby incorporated by reference in its entirety.

### BACKGROUND OF THE INVENTION

### Field of the Invention

The present invention provides a snorkeling tube structure and a method of manufacturing the same. In particular, the present invention provides a snorkeling tube structure for use in a snorkeling or diving sport equipment and a method of manufacturing the same.

### Descriptions of the Related Art

Snorkeling tubes are widely used in snorkeling or diving sports and are generally combined with a mouthpiece portion or a mask so that a user can breathe when underwater. To achieve this purpose, snorkeling tubes are generally long tubes with an end thereof above the water.

A tube body of a conventional snorkeling tube only has a single air passage, so the fresh air above the water that is inhaled by the user and the exhaust air containing carbon dioxide exhaled by the user all pass through the single air passage. However, the user will inevitably inhale the carbon dioxide exhaled by himself/herself when the user breathes through such a snorkeling tube, thereby lowering the oxygen content in the air inhaled by the user. Therefore, the user is likely to feel dizzy or feel the need to rise to the surface of the water frequently so that the user cannot do the snorkeling or diving sport for a long time.

Although manufacturers have attempted to develop a snorkeling tube with an intake passage and an outtake passage separated from each other, the snorkeling tube cannot meet the users' requirements due to limitations in the injection molding process.

Accordingly, a need exists in the art to improve the aforesaid drawbacks.

### SUMMARY OF THE INVENTION

An objective of the present invention is to provide a snorkeling tube structure, which has an intake passage and an outtake passage separated from each other and has an appropriate shape, size and/or strength, as well as a method of manufacturing the same.

To achieve the aforesaid objective, a snorkeling tube structure provided in the present invention comprises the following: a tube body, formed along an axis and comprising an outer surface and an inner surface opposite to the outer surface, wherein the inner surface encircles the axis to define an air passage, and the axis comprises a curved section; and a partition portion, along the axis, formed integrally with the tube body, and disposed on the inner surface to divide the air passage into an intake passage and an outtake passage.

To achieve the aforesaid objective, a snorkeling tube structure provided in the present invention comprises the following components: a tube body, formed along an axis and comprising an outer surface and an inner surface opposite to the outer surface, wherein the inner surface encircles the axis to define an air passage; and a partition portion, along the axis, formed integrally with the tube body, and disposed on the inner surface to divide the air passage into an intake passage and an outtake passage; wherein at least the tube body or the partition portion has a thickness which is not greater than 3.0 millimeters, or even not greater than 1.5 millimeters.

In an embodiment, the partition portion comprises a plate.

In an embodiment, at least the tube body or the partition portion has a thickness which is not greater than 1.0 millimeter and which may also be not greater than 0.7 millimeters and not lesser than 0.5 millimeters.

In an embodiment, the axis of the snorkeling tube structure comprises two end points between which a straight distance is defined. The straight distance is not lesser than 320 millimeters.

In an embodiment, the tube body comprises a section surface which is vertical to the axis and connects to the outer surface and the inner surface. The shape of the section surface could be a heart, water drop, star, plum blossom or triangle.

To achieve the aforesaid objective, a method of manufacturing a snorkeling tube structure provided in the present invention comprises the following steps: forming a parison, wherein the parison includes a first passage and a second passage separated to each other; placing the parison in a mold cavity of a mold; injecting air into the first passage and the second passage to inflate the parison towards a wall of the mold cavity; and removing the inflated parison from the mold to get a snorkeling tube structure.

In an embodiment, the step of forming the parison comprises the extrusion of a plastic material from a die head to get the parison which comprises an air passage.

In an embodiment, the step of forming the parison comprises the injection of a plastic material into an injection mold, and then removing the plastic material from the injection mold to get the parison which comprises an air passage.

In an embodiment, the step of forming the parison further comprises the deformity of the parison to divide the air passage of the parison into a first passage and a second passage.

In an embodiment, the step of forcing the parison to deform comprises the placement of the parison between two clamp plates; and clamping two portions of the parison with the two clamp plates, so that the two portions attach to each other to divide the air passage into the first passage and the second passage.

In an embodiment, the step of forming the parison comprises the injection of a plastic material into an injection mold, and then removing the plastic material from the injection mold to get the parison which comprises the first passage and the second passage.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a snorkeling tube structure used in a snorkel according to the preferred embodiment of the present invention;

FIG. 2 is a cross-sectional view of the snorkeling tube structure shown in FIG. 1 in the longitudinal direction;

FIG. 3 is a cross-sectional view of the snorkeling tube structure shown in FIG. 2 taken along line A-A (in the horizontal direction);

FIG. 4 is a schematic view illustrating different section surfaces of the snorkeling tube structure shown in FIG. 1 in the horizontal direction;

FIG. 5 is a schematic view illustrating the formation of a parison through an extrusion process, in a method of manufacturing a snorkeling tube structure according to the preferred embodiment of the present invention;

FIGS. 6A and 6B are process schematic views illustrating the formation of the parison through an injection process, in a method of manufacturing a snorkeling tube structure according to the preferred embodiment of the present invention;

FIGS. 7A to 7C are process schematic views illustrating the step of forcing the parison to deform, in a method of manufacturing a snorkeling tube structure according to the preferred embodiment of the present invention; and

FIGS. 8A and 8B are process schematic views illustrating a step of inflating the parison, in a method of manufacturing a snorkeling tube structure according to the preferred embodiment of the present invention.

### DESCRIPTION OF THE PREFERRED EMBODIMENT

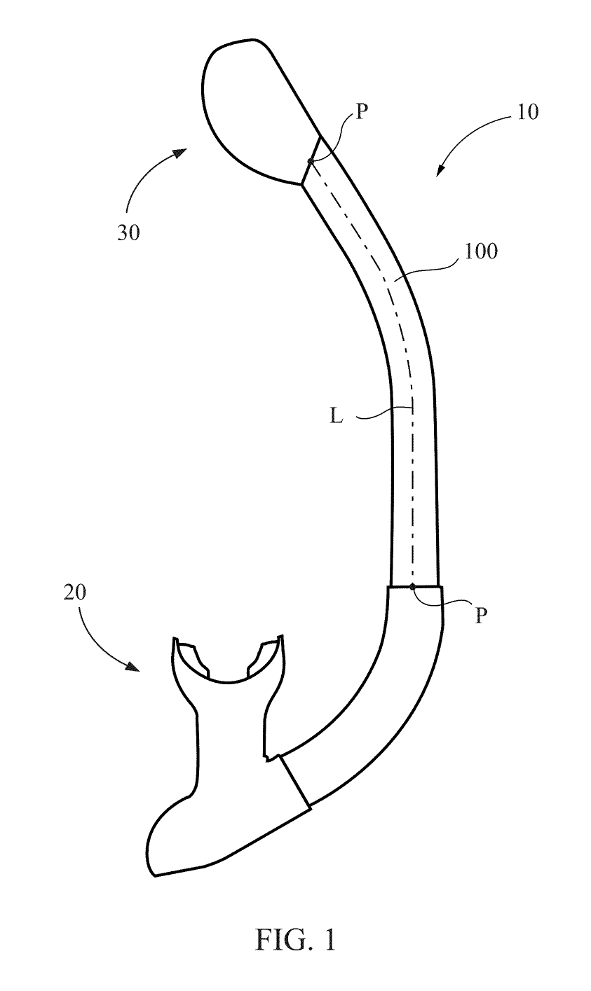

FIG. 1 illustrates a schematic view of a snorkeling tube structure 10 according to the preferred embodiment of the present invention. The snorkeling tube structure 10 may be used in a snorkel (as a constitute element of the snorkel), and may be connected to elements such as a mouthpiece assembly 20 and a waterproof member 30 of the snorkel. The snorkeling tube structure 10 may also be used in a goggle mask (not shown) with an overall mask, e.g., a goggle mask structure disclosed in a Taiwan patent application No. 106116199 applied by the applicant.

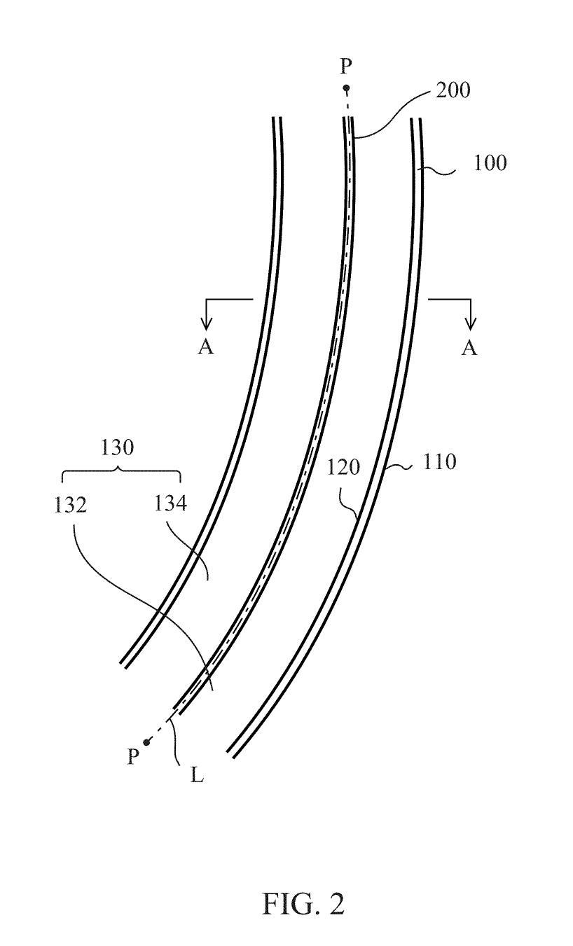

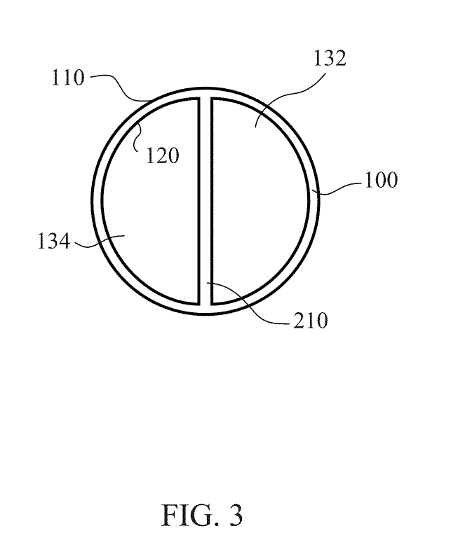

The snorkeling tube structure 10 may be manufactured by blow molding (specific technical contents thereof will be described later), so the shape, size and/or strength of the snorkeling tube structure 10 are all different from conventional snorkeling tubes manufactured by injection molding and the snorkeling tube structure 10 can meet different requirements. FIGS. 2 and 3 together are respectively a longitudinal cross-sectional view and a horizontal cross-sectional view of the snorkeling tube structure 10. The snorkeling tube structure 10 may comprise a tube body 100 and a partition portion 200, the technical contents of which are described sequentially as follows.

The tube body 100 is formed by extending along an axis L which is an imaginary line. That is, there are a plurality of section surfaces between one opening end and another opening end of the tube body 100 (e.g., as shown in FIG. 3), and the axis L vertically passes through the centroid of the section surfaces. Parts of the tube body 100 are formed integrally instead of being assembled together as multiple pieces. The tube body 100 comprises an outer surface 110 and an inner surface 120 opposite to the outer surface 110 (and the section surfaces connects to the outer surface 110 and the inner surface 120). The inner surface 120 encircles the axis L to define an air passage 130. In other words, the space encircled by the inner surface 120 is the air passage 130. The air inhaled or exhaled by the user flows in the air passage 130.

The axis L comprises a curved section (i.e., a non-straight section). In detail, the axis L may be a bent section that is bent continuously (i.e., the curvature of the curve is variable) or the axis L may comprise at least one straight section and at least one curved section. In other words, the tube body 100 formed by blow molding may be a curved tube on the whole, or a part of the tube body 100 is a straight tube and the other part thereof is a curved tube. In this way, a part of the curved tube body 100 will not interfere with the sight of the user or be hard to wear, and can have a more streamlined appearance. If the snorkeling tube structure 10 is used for a goggle mask with an overall mask, then the snorkeling tube structure 10 may be a straight tube on the whole without curved portions. In other words, the axis L does not include any curved section.

On the other hand, the axis L further comprises two end points P, and a straight distance (i.e., a connecting straight line between the two end points P) is defined between the two end points P. The straight distance may be not lesser than 320 millimeters. In other words, the tube length of the tube body 100 formed by blow molding is greater than 320 millimeters, e.g., may be up to 350 millimeters or 400 millimeters in response to the length of the faces of different users.

The partition portion 200 may comprise a plate 210 and also extend along the axis L. The partition portion 200 is formed integrally with the tube body 100. In other words, the partition portion 200 and the tube body 100 are formed simultaneously with the same material and through the blow molding. Corresponding to the shape of the tube body 100, the partition portion 200 may be a curved plate on the whole. A part of the partition portion 200 is a straight plate and the other part thereof is a curved plate. Moreover, the partition portion 200 is disposed on the inner surface 120 of the tube body 100 to divide the air passage 130 into an intake passage 132 and an outtake passage 134. In other words, the partition portion 200 may divide the air passage 130 into two portions along the axis L. One or more one-way valves (not shown) may be provided within the intake passage 132 and the outtake passage 134 so that the intake passage 132 only allows the air to pass therethrough in one direction while the outtake passage 134 only allows the air to pass therethrough in another opposite direction. Additionally, the air respectively flowing in the intake passage 132 and the outtake passage 134 cannot communicate and mix with each other.

In this way, the user can inhale fresh air via the intake passage 132 and exhale air containing carbon dioxide via the outtake passage 134, thereby avoiding inhaling the carbon dioxide exhaled by the user himself/herself. Thus, the user can use the snorkeling tube structure 10 for a longer period of time or use the snorkeling tube structure 10 more comfortably. That is, the user is less likely to feel dizzy, and the accumulation of nitrogen in the body of the user may also be reduced. Moreover, using the snorkeling tube structure 10 with such a configuration in the goggle mask having the overall mask may further effectively reduce the generation of haze in the mask.

The snorkeling tube structure 10 formed by blow molding may have multiple options in the material thereof. The material of the snorkeling tube structure 10 is not limited to soft materials or hard materials, and it may for example include materials with good flowability, such as polyvinyl chloride (PVC), thermoplastic elastomer (TPR), or thermoplastic polyurethane (TPU) substrates, or other materials such as poly carbonate (PC), acrylonitrile butadiene styrene (ABS), ethylene vinyl acetate (EVA), polypropylene (PP), high density polyethylene (HDPE), low density polyethylene (LDPE), polyethylene terephthalate (PET) or the like. The processing temperatures of these materials during the blow molding are relatively low, e.g., the processing temperature of the polypropylene (PP) is 210° C. to 230° C., the processing temperature of the high density polyethylene (HDPE) is 170° C. to 220° C., the processing temperature of the low density polyethylene (LDPE) is 150° C. to 190° C., and the processing temperature of the polyvinyl chloride (PVC) is 180° C. to 200° C. Therefore, as compared to other molding techniques, the blow molding uses working equipments and processing environments with relatively low requirements and thus, the production cost thereof is relatively low.

Furthermore, the snorkeling tube structure 10 formed by blow molding may have a relatively small thickness in the tube wall thereof. That is, the tube body 100 and/or the partition portion 200 may have a thickness which is not greater than 3.0 millimeters, preferably not greater than 1.5 millimeters, not greater than 1 millimeter, not greater than 0.7 millimeters and even not greater than 0.5 millimeters so that the snorkeling tube structure 10 has a light weight. Additionally, the snorkeling tube structure 10 with a relatively small tube thickness may have a relatively large intake passage 132 and outtake passage 134, so the flow resistance of air therein is relatively small and the user can breathe more smoothly and easily.

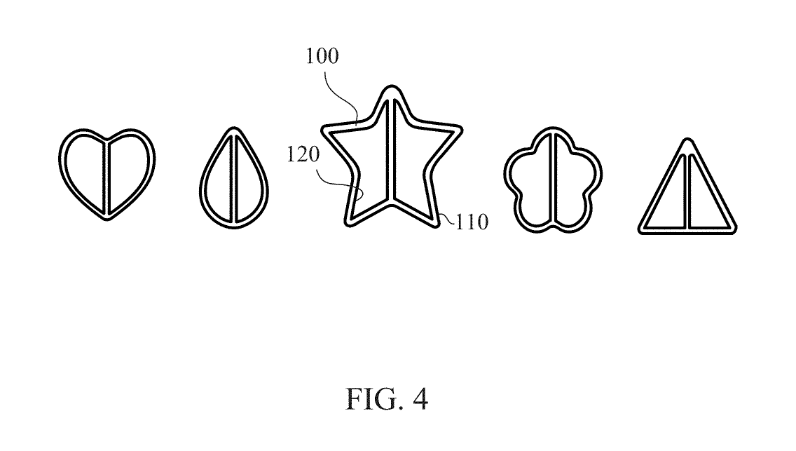

In addition to the section surface shown in FIG. 3, the tube body 100 of the snorkeling tube structure 10 may also form section surfaces of other shapes as shown in FIG. 4 to adapt to preferences of consumers. The shapes may for example include: square, oval, heart, water drop, star, plum blossom or triangle.

The method of manufacturing a snorkeling tube structure according to the preferred embodiment of the present invention will be described hereinafter. This manufacturing method may manufacture a snorkeling tube structure which is the same as or similar to the snorkeling tube structure 10 of the above embodiments, so reference may be made to technical contents of the snorkeling tube structure 10 for technical contents of the manufacturing method, and the same portions therebetween will be omitted or simplified.

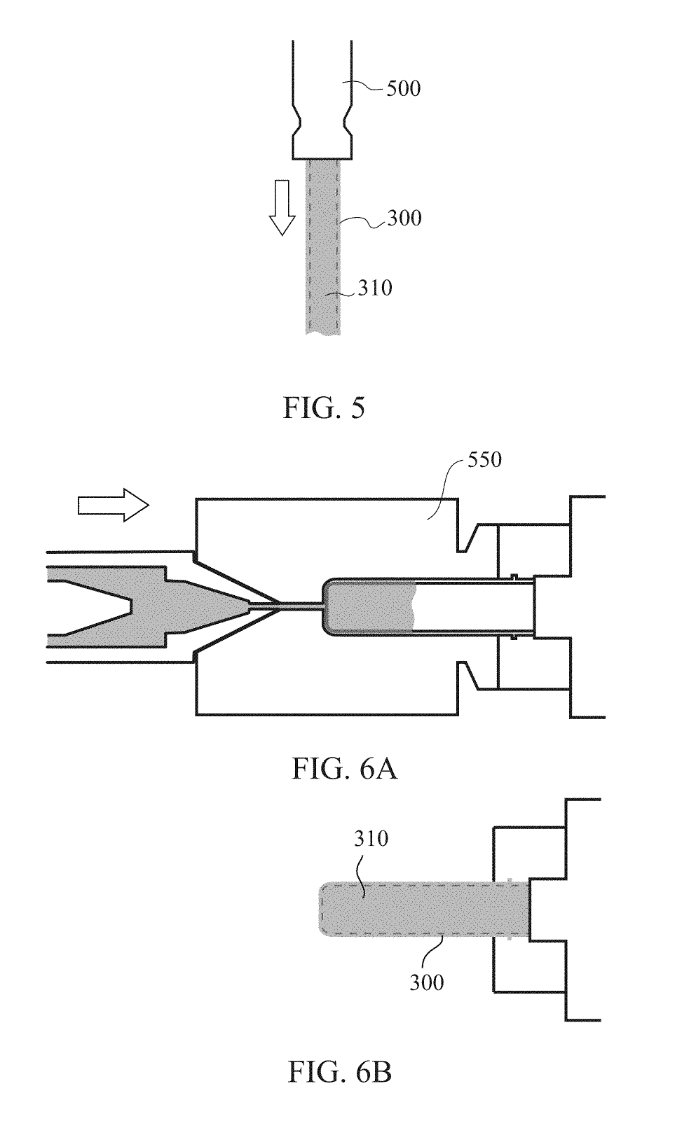

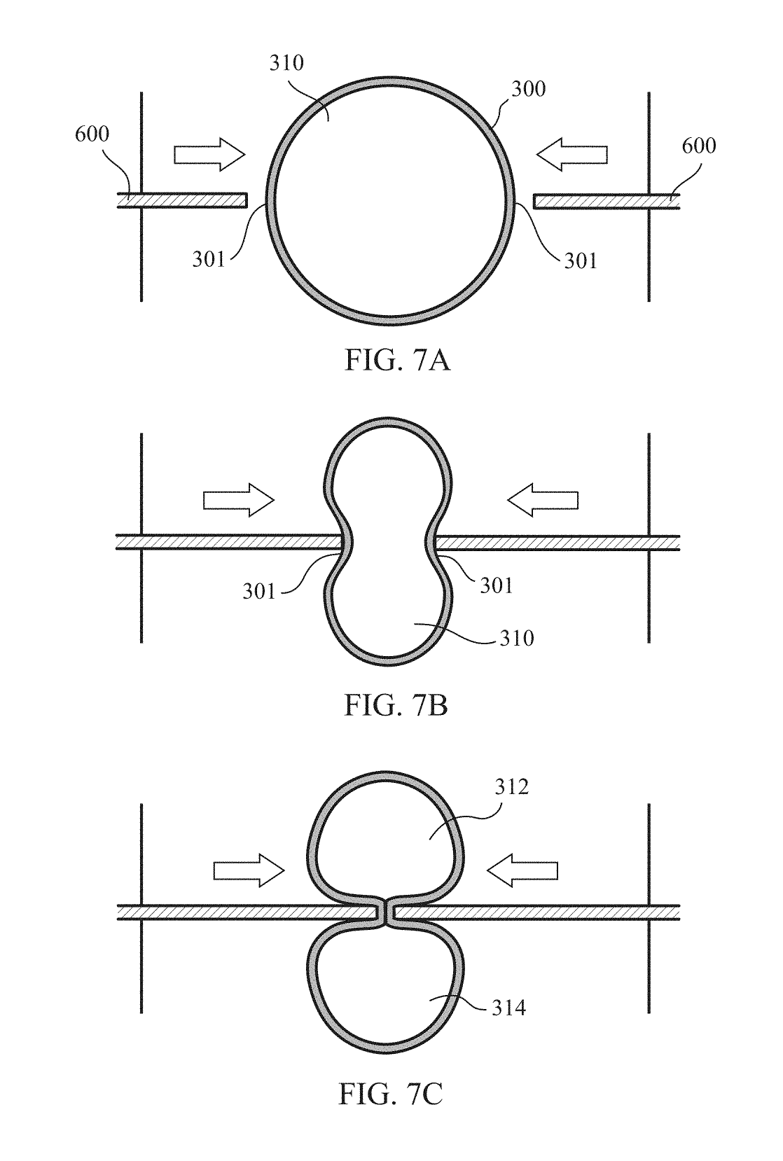

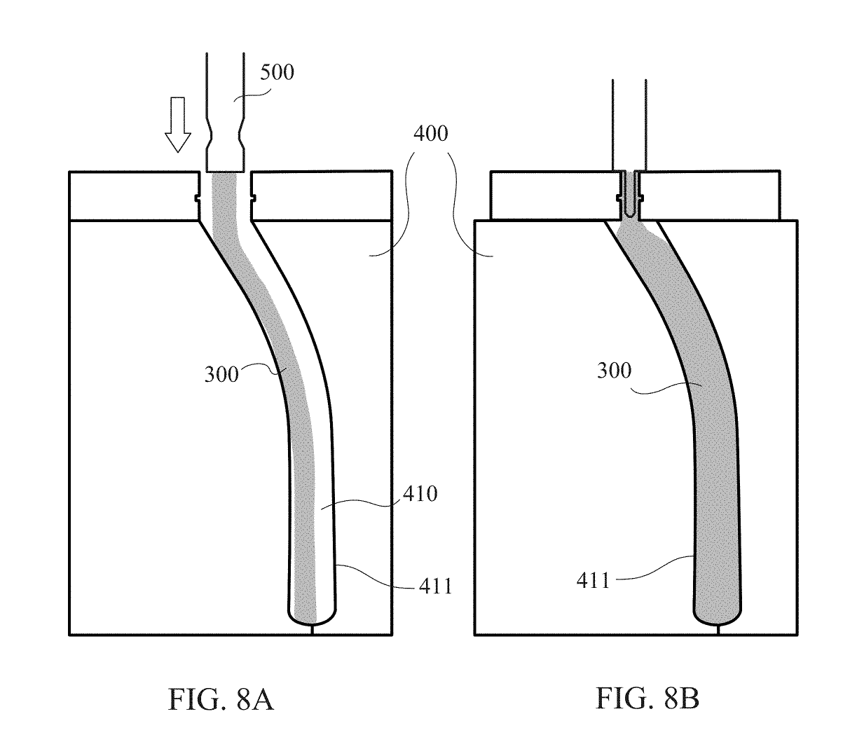

The manufacturing method uses the blow molding technique and may comprise the following main steps: forming a parison 300 (as shown in FIG. 5 or FIG. 6B), wherein the parison 300 includes a first passage 312 and a second passage 314 separated from each other (as shown in FIG. 7C); placing the parison 300 in a mold cavity 410 of a mold 400 (as shown in FIG. 8A); injecting air into the first passage 312 and the second passage 314 (not shown) to inflate the parison 300 towards a wall 411 of the mold cavity 410 (as shown in FIG. 8B); and removing the inflated parison 300 from the mold 400 to get a snorkeling tube structure 10 (as shown in FIG. 1). The technical contents of each of the steps will be described sequentially hereinafter.

As shown in FIG. 5, the step of forming the parison 300 comprises the following steps: extruding a plastic material from a die head 500 through an extrusion process to get the parison 300 which comprises an air passage 310. Alternatively, the step of forming the parison 300 comprises: injecting a plastic material into an injection mold 550, and then removing the plastic material from the injection mold to get the parison 300 which comprises an air passage 310, as shown in FIG. 6A and FIG. 6B. However, the step is not limited thereto. Additionally, the parison 300 comprising the first passage 312 and the second passage 314 may be formed directly in injection molds due to the different design of the injection mold.

To make the snorkeling tube structure 10 have a separated air passage 310 after forming the parison 300, the step of forming the parison 300 further comprises: forcing the parison 300 to deform, so as to divide the air passage 310 of the parison 300 into a first passage 312 and a second passage 314.

In detail, as shown in FIG. 7A to FIG. 7C, the step of forcing the parison 300 to deform may comprise: placing the parison 300 between two clamp plates 600 and clamping two portions 301 of the parison 300 by the two clamp plates 600, so that the two portions 301 attach to each other to preliminarily divide the air passage 310 into the first passage 312 and the second passage 314.

Subsequently, as shown in FIGS. 8A and 8B, the parison 300 is placed in the mold cavity 410 of the mold 400, and then air (not shown) is injected into the first passage 312 and the second passage 314 of the parison 300 to inflate the parison 300 (enlarge the first passage 312 and the second passage 314) towards the wall 411 of the mold cavity 410, thereby forming the snorkeling tube structure 10 with a section surface as shown in FIG. 3 or FIG. 4. The inflated parison 300 is removed from the mold 400 after being cured, thereby completing the manufacturing of the snorkeling tube structure 10.

In shall be additionally appreciated that when the parison 300 is formed through the extrusion process, the parison 300 may be formed under a relatively low pressure, e.g., 0.2 MN to 1.0 MN. The snorkeling tube structure 10 formed by inflating the parison 300 formed under a low pressure may have a relatively small residual stress, so it may have a relatively large resistance to strains such as stretching, impact and bending.

According to the above descriptions, the snorkeling tube structure of the present invention is manufactured through blow molding, and has an intake passage and an outtake passage separated from each other to help the user breathe. The shape of the snorkeling tube structure is not limited, and may have a relatively large length and/or a relatively small thickness. Moreover, the snorkeling tube structure also has a relatively good structural strength and a relatively low manufacturing cost.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A snorkeling tube structure, comprising:
a tube body, formed by extending along an axis and comprising an outer surface and an inner surface opposite to the outer surface, wherein the inner surface encircles the axis to define an air passage, and the axis comprises a curved section; and
a partition portion, extended along the axis, formed integrally with the tube body, and disposed on the inner surface to divide the air passage into an intake passage and an outtake passage.

2. The snorkeling tube structure according to claim 1, wherein the partition portion comprises a plate.

3. The snorkeling tube structure according to claim 1, wherein at least one of the tube body and the partition portion has a thickness which is not greater than 3.0 millimeters.

4. The snorkeling tube structure according to claim 3, wherein the thickness is not greater than 1.5 millimeter.

5. The snorkeling tube structure according to claim 1, wherein the axis comprises two end points between which a straight distance is defined, and the straight distance is not lesser than 320 millimeters.

6. The snorkeling tube structure according to claim 1, wherein the tube body comprises a section surface which is vertical to the axis and connects to the outer surface and the inner surface, and a shape of the section surface comprises heart, water drop, star, plum blossom or triangle.

7. A snorkeling tube structure, comprising:
a tube body, formed by extending along an axis and comprising an outer surface and an inner surface opposite to the outer surface, wherein the inner surface encircles the axis to define an air passage; and
a partition portion, extended along the axis, formed integrally with the tube body, and disposed on the inner surface to divide the air passage into an intake passage and an outtake passage;
wherein at least one of the tube body and the partition portion has a thickness which is not greater than 3.0 millimeters.

8. The snorkeling tube structure according to claim 7, wherein the thickness is not greater than 1.5 millimeter.

9. The snorkeling tube structure according to claim 8, wherein the thickness is not greater than 0.7 millimeters, and not lesser than 0.5 millimeters.

10. The snorkeling tube structure according claim 7, wherein the partition portion comprises a plate.

11. The snorkeling tube structure according to claim 7, wherein the tube body comprises a section surface which is vertical to the axis and connects to the outer surface and the inner surface, and a shape of the section surface comprises heart, water drop, star, plum blossom or triangle.

12. A method of manufacturing a snorkeling tube structure, comprising:
forming a parison, wherein the parison includes a first passage and a second passage separated to each other;
placing the parison in a mold cavity of a mold;
injecting air into the first passage and the second passage to inflate the parison towards a wall of the mold cavity; and
removing the inflated parison from the mold to get a snorkeling tube structure.

13. The method according to claim 12, wherein the step of forming the parison comprises: extruding a plastic material from a die head to get the parison which comprises an air passage.

14. The method according to claim 12, wherein the step of forming the parison comprises: injecting a plastic material into an injection mold, and then removing the plastic material from the injection mold to get the parison which comprises an air passage.

15. The method according to claim 13, wherein the step of forming the parison further comprises: forcing the parison to deform, so as to divide the air passage of the parison into a first passage and a second passage.

16. The method according to claim 15, wherein the step of forcing the parison to deform comprising:
placing the parison between two clamp plates; and
clamping two portions of the parison by the two clamp plates, so that the two portions attach to each other, so as to divide the air passage into the first passage and the second passage.

17. The method according to claim 12, wherein the step of forming the parison comprising:
injecting a plastic material into an injection mold, and then removing the plastic material from the injection mold to get the parison which comprises the first passage and the second passage.
